(19) United States
(12) Patent Application Publication
(10) Pub. No.: US 2026/0117946 A1
(43) Pub. Date: Apr. 30, 2026

(54) DEVICE FOR IMPLEMENTING CIRCADIAN-EFFECTIVE LIGHTING AT A WORKSTATION

(71) Applicant: Sylvan R. Shemitz Designs, LLC, West Haven, CT (US)

(72) Inventor: David R. Pfund, Woodbridge, CT (US)

(21) Appl. No.: 19/316,416

(22) Filed: Sep. 2, 2025

Related U.S. Application Data
(60) Provisional application No. 63/690,848, filed on Sep. 5, 2024.

(51) Int. Cl. F21S 6/00; F21V 7/04; F21V 17/10

(52) U.S. Cl. CPC F21S 6/003; F21V 7/04; F21V 17/107

(57) ABSTRACT

A task light for illuminating a work surface of a work station, the task light including a lighting element configured to emit light output in a direction toward the work surface, a redirection member maneuverable between a stowed position and a use position, where, when the redirection member is in the use position a portion of the light output is directed toward a face of an occupant of the work station, and where, when the redirection member is in the stowed position, the portion of light is not directed toward the face of said occupant.

### CROSS-REFERENCE TO RELATED APPLICATION

This application is related to and claims the benefit of U.S. Provisional Patent Application Ser. No. 63/690,848 filed on Sep. 5, 2024, the entire contents of which are herein incorporated by reference.

### TECHNICAL FIELD

The disclosure relates to the field of lighting in general and, in particular, to a system and device for implementing circadian-effective lighting at a workstation, for example, in a commercial or home office space.

### BACKGROUND

The design and deployment of lighting systems for offices and workplaces are typically configured for achieving target levels of illuminance on horizontal worksurfaces while limiting energy consumption. Recognizing that using a general or ambient lighting system to achieve the targeted task illuminance throughout the entire workspace is wasteful in terms of energy consumption, it is common to reduce the overall general lighting level in offices and deploy task lights proximate to the primary worksurface at each workstation to achieve the target horizontal illuminance on an as-needed and where-needed basis. However, recent studies have associated a certain amount and duration of illuminance at the eye during the day with human health outcomes and such have determined that these energy-efficient, low-ambient indoor environments are ineffective in providing occupants with the circadian stimulus required for entraining the human circadian system and promoting overall health. Moreover, it is known that circadian stimulus applied early in the day promotes sleep quality and healthy sleep-wake cycles while circadian stimulus at other times of day, especially late in the day and in the evening, is less desirable, and in some cases, detrimental.

One method to deliver circadian stimulus to the occupants of an office space is to design the general lighting system to deliver more light throughout the office, effectively raising the ambient light levels. Another method is to deploy luminaires at office workstations to deliver light directly to the eyes of the workstation occupants. Research shows that the most impactful and most energy-efficient strategy is to supplement the general lighting with desktop luminaires delivering light directly to the occupants' eyes.

However, most workstation task lights are not designed to deliver circadian stimulus to the workstation occupant, and adding an additional luminaire to a workstation or adding an additional light source (e.g. an additional LED array) to a task light for the purposes of delivering circadian stimulus at certain times of the day adds significant complexity and cost and increases overall office energy consumption. Likewise, luminaires designed to deliver circadian stimulus are not known to simultaneously operate as an effective task light, i.e. to effectively and efficiently direct light to a horizontal worksurface to aid the occupant in the execution of visual tasks while providing for circadian stimulus. In fact, delivering broad-coverage task lighting on worksurfaces in conjunction with a luminous source of circadian stimulus at a workstation is most desirable to limit luminance ratios that impact visual comfort.

What is needed is a device associated with a workstation task light that can be easily positioned by a workstation occupant to cause said task light to deliver circadian-effective light to said workstation occupant during a certain time period of occupying said workstation without otherwise compromising the delivery of said task light to illuminate a worksurface of said workstation and without adding to the power consumption of said workstation.

Furthermore, what is needed is for said device to be easily positioned by said workstation occupant to cause said task light to NOT deliver circadian-effective light to said workstation occupant during a certain time period of occupying said workstation.

### BRIEF SUMMARY

In order to address the deficiencies in the prior art noted above, a device is disclosed for redirecting a portion of the output of a workstation task light toward the eyes of a workstation occupant whereby the portion of output may not otherwise contribute to illuminating a worksurface of the workstation and, upon reaching the eyes of the occupant, provides a desirable circadian effect.

### BRIEF DESCRIPTION OF THE DRAWINGS

For a more complete understanding of this disclosure, reference is now made to the following brief description, taken in connection with the accompanying drawings and detailed description, wherein like reference numerals represent like parts, in which:

FIGS. 1-9 show various exemplary embodiments of a device in accordance with the disclosure including a task light for use in a work station configured to selectively provide illumination to the face of an occupant.

### DETAILED DESCRIPTION

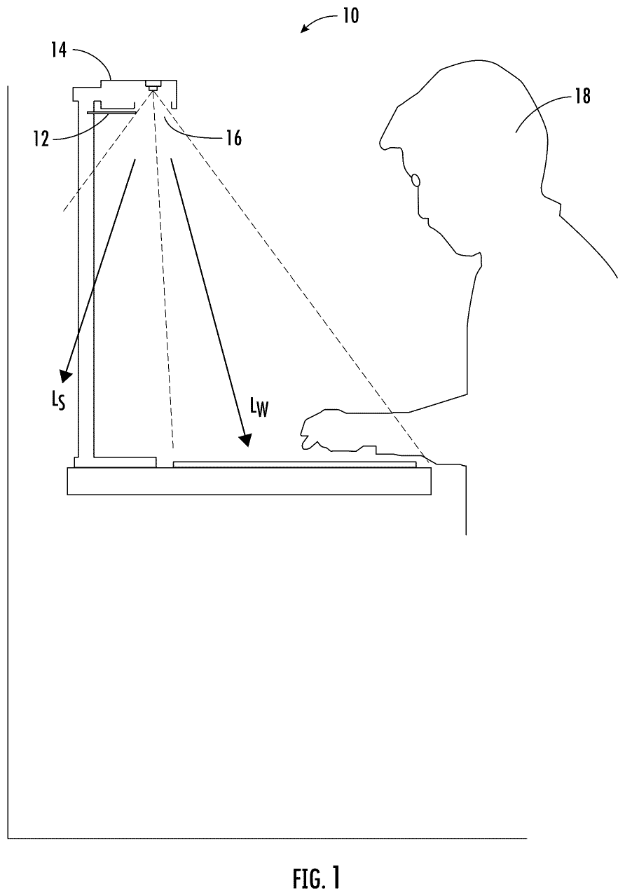

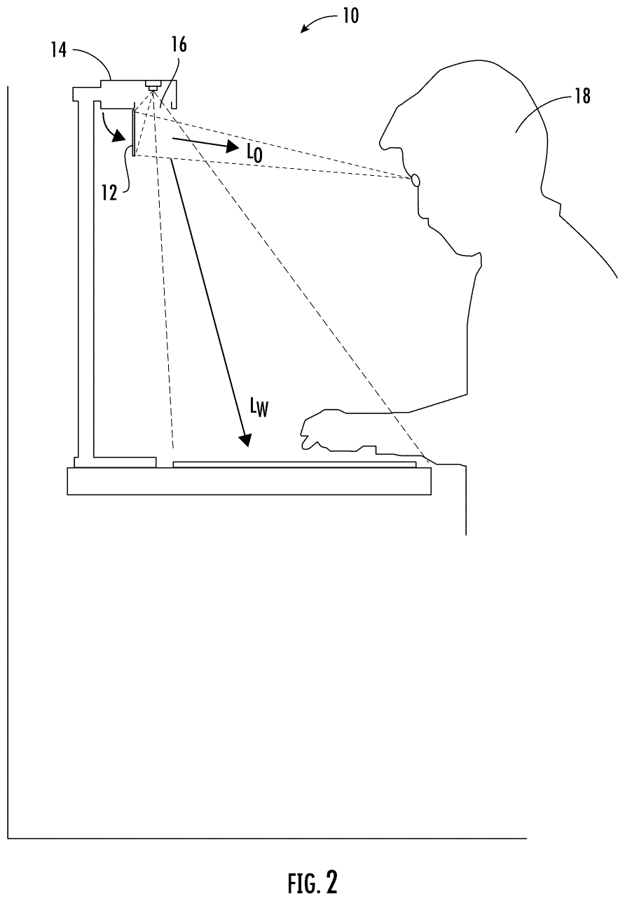

In one embodiment, as illustrated by way of example in FIGS. 1-2, a device 10 according to the present disclosure comprises a reflective panel 12 adjustably affixed to a task light 14 proximate to an aperture 16 of the task light 14 such that the workstation occupant 18 can pivot the panel 12 into a first use position (shown in FIG. 2) that delivers a circadian effective lighting and such that the workstation occupant 18 can pivot the panel 12 into a second stowed position that does not deliver any circadian stimulus (shown in FIG. 1).

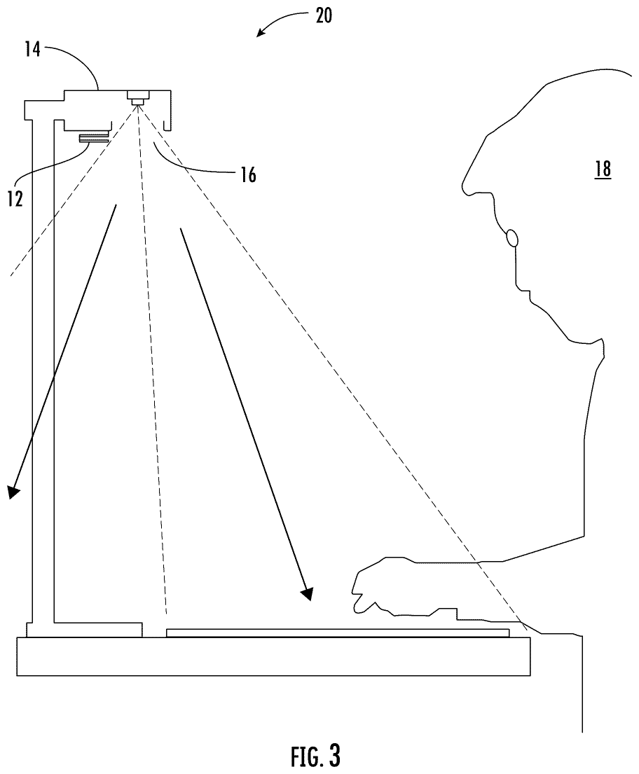

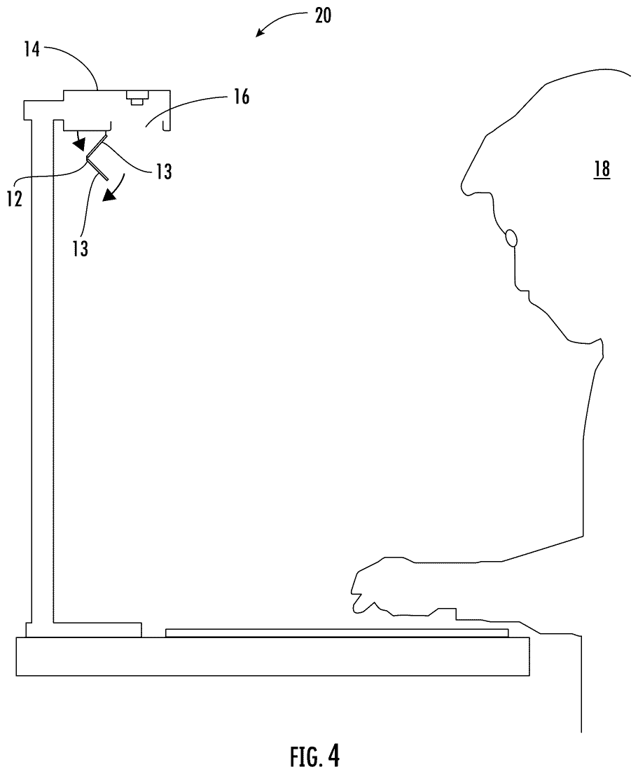

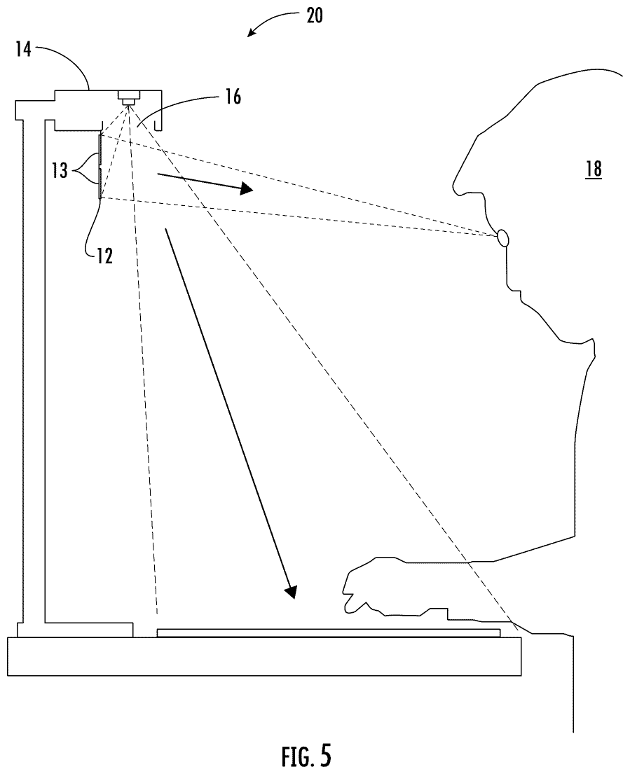

In another embodiment of the device, as shown illustratively in FIGS. 3-5 generally at reference numeral 20, the reflective panel 12 described above comprises two or more segments 13 that fold upon each other when the task light 14 is not delivering a circadian stimulus (shown in FIG. 3) and can be unfolded by the workstation occupant 18 to deliver the circadian effect (shown in FIGS. 4-5).

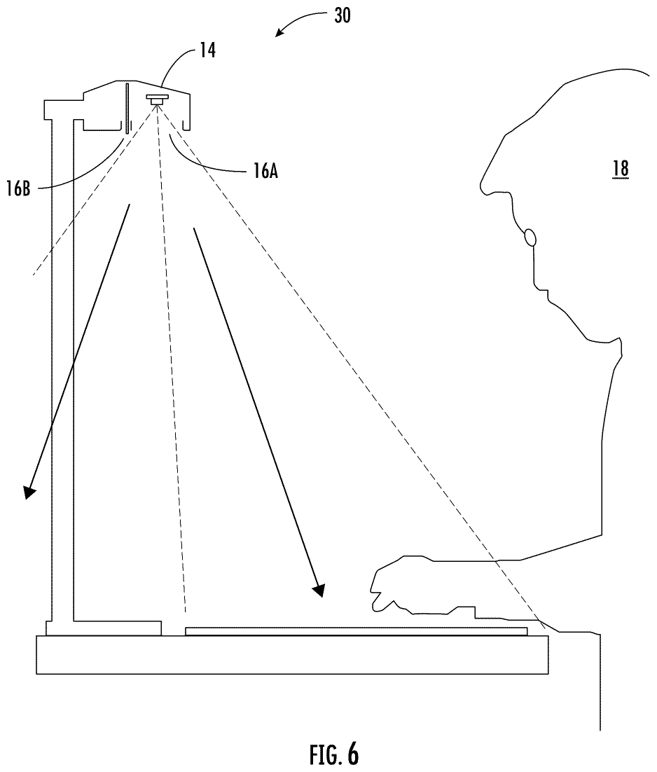

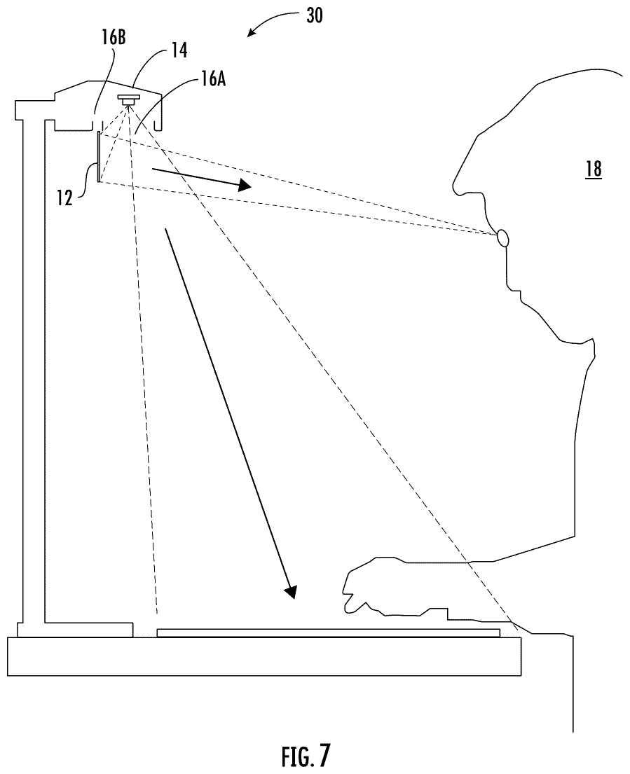

In still a further embodiment, a device 30 in accordance with the present disclosure is illustrated at FIGS. 6-7 as including the task light 14 arranged above a worksurface, proximate to the occupant 18, but here the task light 14 includes a first aperture 16A for emitting light toward the work surface and a second aperture 16B through which the reflective panel 12 may be extended or retracted. When retracted, as shown in FIG. 6, the light emitted from the task light 14 proceeds unencumbered. When the reflective panel 12 is extended, as shown in FIG. 7, a portion of the light emitted from the task light is redirected toward the occupant 18 in order to deliver a circadian stimulus.

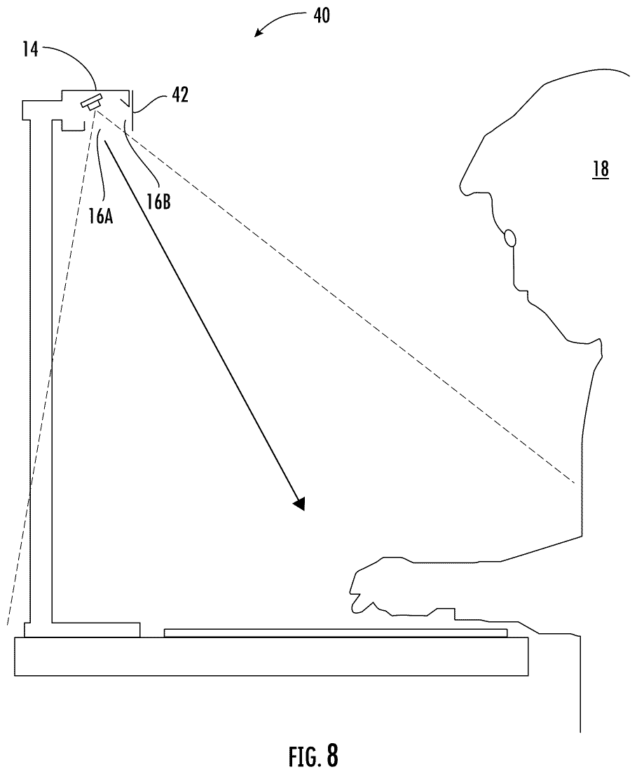

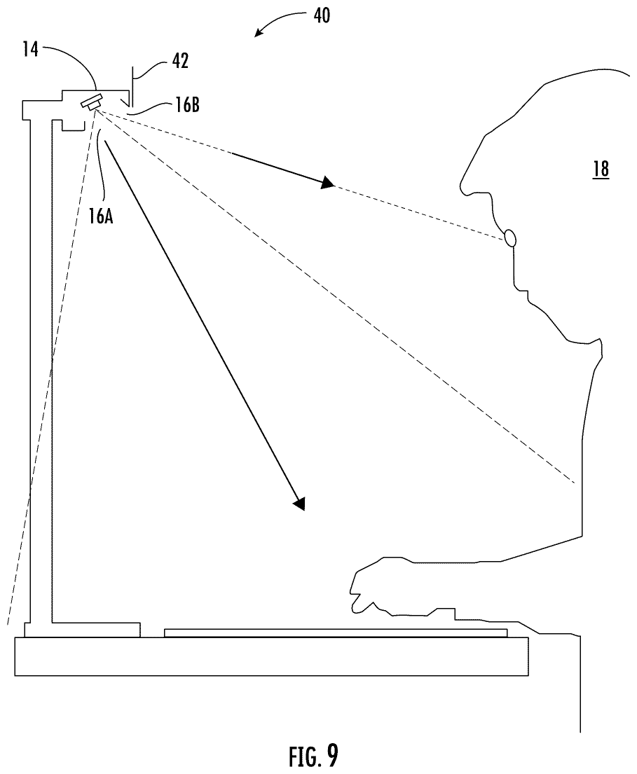

In another embodiment of the device, shown generally at 40 in FIGS. 8-9, the task light 14 has a first and second aperture 16A, 16B, or an aperture with a first and second portion 16A, 16B, said first aperture or aperture portion 16A configured to direct a portion of the output to a worksurface and said second aperture or aperture portion 16B configured to direct a portion of the output to the eyes of the workstation occupant, and the device 40 includes an adjustable opaque panel 42 covering said secondary aperture or portion 16B. In this embodiment, the operator may adjust or “open” the panel 42 to deliver a circadian stimulus (shown in FIG. 9) and adjust or “close” the panel 42 to avoid a circadian effect (shown in FIG. 8).

Additional drawings, illustrations, examples and explanations are provided after FIG. 9, which form a part of the present disclosure.

This invention anticipates that the spectral output and intensity of the task light and the reflective characteristics of the reflective panel (where occurs) are selected and fashioned to achieve a desirable circadian effect according to one of any research-based circadian effect metrics such as a circadian stimulus of CS≥0.30 as defined by The Lighting Research Center (www.lrc.rpi.edu/cscalculator) and prescribed in UL Standard 24480 by Underwriters Laboratory.

It is also noted that general office lighting and workstation task lights designed to illuminate horizontal worksurfaces do not adequately or desirably illuminate workstation occupants conducting video conference calls. This deficiency is often overcome by adding one or more luminaire(s), such as an LED “ring” light, at the workstation to illuminate the face of the workstation occupant during conference calls. Such luminaires add clutter and cost to workstations and add to the overall energy consumption of the office. Another method is to use an adjustable task light that can be positioned or “aimed” by the workstation occupant for self-illumination instead of lighting the worksurface when participating in video conferences. However, using an adjustable task light in this manner does not allow for simultaneously lighting the worksurface and the workstation occupant.

Therefore, another advantage of the present invention is the ability for workstation occupant to easily position the device to cause the task light to effectively illuminate the occupant during video conference sessions without otherwise compromising the delivery of task light to illuminate a worksurface of the workstation and without adding to the power consumption of the workstation. Furthermore, said device is easily positioned by the workstation occupant to cause the task light to illuminate only the worksurface.

The embodiments of the invention disclosed herein advantageously provide a selective redistribution of light output from a work station task light that can be used by a work station occupant for illumination during a video call or for exposure in order implement a circadian stimulus. Notably, the output which is redirected from the task light to the work station occupant for these purposes does not diminish illumination of the work surface by the task light. That is, “spill light” is redirected to the work station occupant for illumination or exposure purposes, not output that is directly incident on the work surface. FIG. 1 illustrates spill light L_{S} which is emitted from the task light 14 incident upon surfaces other than the work surface. In this example, the spill light L_{S} is directed toward the rear of the work station, e.g., toward an upright element supporting the task light and/or toward an office wall or a partition used to the define the work station. To the contrary work surface light L_{W} is emitted from the task light incident upon the work surface. FIG. 2 shows occupant light L_{O} reflected by the panel 12 and directed toward the occupant 18. The occupant light L_{O} is a mere redirection of the spill light L_{S}. Thus, even with the panel 12 in the reflecting position, the work surface is still fully illuminated by the work surface light L_{W}. The device of the invention essentially repurposes the spill light L_{S} for video illumination or circadian stimulus purposes without degrading the illumination of the work surface.

The extent of reflection provided by the reflective panel can be customized or tuned for a particular application. For example, the reflective panel may include a highly reflective surface composed of a mirror or other highly polished material. Alternatively, a less reflective material may be used in order to reduce the intensity of reflected light and reduce glare. Further, a gradient pattern may be used on the reflective surface of the panel to manage luminance and minimize glare. The gradient pattern may interact with the task light to deliver comfortable circadian-effective light. Also, the surface area of the reflective panel may be controlled in order to effect the intensity of reflective light.

Various embodiments of a task light have been disclosed herein as including a single reflective panel than is maneuverable from a stowed position into a use position in which the panel redirects output from the task light to the work station occupant for video illumination and/or circadian stimulus purposes. The disclosed embodiments are merely exemplary. Additional embodiments may include multiple panels maneuverable from a stowed position into a use position, where each panel is tuned for a different purpose. For example, a task light may include two such panels, one for providing lighting output sufficient for video call illumination, a second panel tuned to provide effective light for circadian purposes.

Also, the task light described herein is merely illustrative. The invention may be applied to any lighting device used for task light in a work station or elsewhere. The exemplary task light of the present disclosure is described as including a down light for illuminating a work surface. The task light of course could include up light features which direct output upward and/or away from the work surface.

Generally, the configurations and descriptions provided herein are exemplary. The broad scope of the invention contemplates additional variations and alternatives.

Various embodiments of the present invention are described herein with reference to the related drawings. Alternative embodiments can be devised without departing from the scope of this invention. It is noted that various connections and positional relationships (e.g., over, below, adjacent, etc.) are set forth between elements in the following description and in the drawings. These connections and/or positional relationships, unless specified otherwise, can be direct or indirect, and the present invention is not intended to be limiting in this respect. Accordingly, a coupling of entities can refer to either a direct or an indirect coupling, and a positional relationship between entities can be a direct or indirect positional relationship.

The term “exemplary” is used herein to mean “serving as an example, instance, or illustration.” Any embodiment or design described herein as “exemplary” is not necessarily to be construed as preferred or advantageous over other embodiments or designs. The terms “at least one” and “one or more” are understood to include any integer number greater than or equal to one, i.e. one, two, three, four, etc. The terms “a plurality” are understood to include any integer number greater than or equal to two, i.e. two, three, four, five, etc. Terms such as “connected to”, “affixed to”, etc., can include both an indirect “connection” and a direct “connection.”

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed:

1. A task light for illuminating a work surface of a work station, the task light comprising:
a lighting element configured to emit light output in a direction toward the work surface;
a redirection member maneuverable between a stowed position and a use position;
wherein, when the redirection member is in the use position a portion of the light output is directed toward a face of an occupant of the work station; and
wherein, when the redirection member is in the stowed position, said portion of light is not directed toward the face of said occupant.

2. The task light of claim 1, wherein the redirection member comprises a reflective panel hingeably affixed to the task light and pivotably moveable from the stowed position to the use position.

3. The task light of claim 2, wherein the redirection member includes a first portion hingeably affixed to the task light and a second portion rotatably connected to the first portion such that the second portion is foldable atop the first portion in the stowed position and the second portion is rotatable into a position coplanar to the first portion to form the use position.

4. The task light of claim 1, wherein the redirection member comprises a reflective panel that is slidably disposed on the task light, wherein the stowed position is at an interior of the task light, and wherein the reflection member is slidably extendable from the interior of the task light in a direction toward the work surface and into the use position.

5. The task light of claim 1, wherein the redirection member comprises an opaque member moveable between the stowed potion, in which the opaque member blocks output from the lighting element in the direction of the face of the occupant, and the use position in which the opaque member is retracted to expose the lighting element such that the output is directed to the face of the occupant.

6. The task light of claim 1, wherein the redirection member comprises a reflective panel, wherein a size and/or a finish of the panel are configured to achieve acceptable surface luminance and sufficient vertical illuminance at an eye level of the occupant to enhance circadian entrainment.

7. The task light of claim 1, wherein the redirection member comprises a reflective panel, and wherein the panel includes at least one of a shaded gradient film and a dot pattern configured to control excessive luminance.

8. The task light of claim 1, wherein the redirection member comprises a reflective panel, and wherein a size and a finish of the panel are configured to achieve acceptable luminance for illumination of the occupant during a video conference.

9. The task light of claim 1, wherein the light output of the lighting element comprises work surface light directed to the work surface and spill light directed away from the work surface, wherein, when the redirection member is in the use position, the spill light is directed toward the face of the occupant while the work surface light remains incident on the work surface.
